(19) United States
(12) Patent Application Publication
(10) Pub. No.: US 2012/0269327 A1
(43) Pub. Date: Oct. 25, 2012

(54) X-RAY WAVEGUIDE

(75) Inventors: Kohei Okamoto, Yokohama-shi (JP); Atsushi Komoto, Moriya-shi (JP); Hirokatsu Miyata, Hadano-shi (JP); Wataru Kubo, Inagi-shi (JP); Takashi Noma, Hadano-shi (JP)

(73) Assignee: CANON KABUSHIKI KAISHA, Tokyo (JP)

(21) Appl. No.: 13/443,054

(22) Filed: Apr. 10, 2012

(30) Foreign Application Priority Data
Apr. 19, 2011 (JP) 2011-093068

(51) Int. Cl. G21K 1/00

(52) U.S. Cl. 378/145

(57) ABSTRACT

An X-ray waveguide includes a cladding and a core. The core has a periodic structure formed in at least one period direction. The periodic structure includes periodically arranged members made of material having different refractive index real parts. The core is surrounded by the cladding in the plane perpendicular to a wave-guiding direction. The Bragg angle obtained from the periodicity of the periodic structure is smaller than the total reflection critical angle at which X-rays are incident on the interface between the cladding and the core. The at least one period direction is the direction of at least one fundamental vector expressing the periodicity of the periodic structure in a plane of the core perpendicular to the wave-guiding direction.

### BACKGROUND OF THE INVENTION

1. Field of the Invention

The present invention relates to X-ray waveguides, and, specifically, to X-ray optical components used in X-ray optical systems for X-ray analytical technology, X-ray image pick-up technology, X-ray exposure technology and so forth.

2. Description of the Related Art

For the control of electromagnetic waves including X-ray waves (X-ray radiation), large-scale spatial optical systems are mainly used. This is because when electromagnetic waves having short wavelengths of several tens of nanometers or less are used, the difference in refractive index among different substances is very small and, accordingly, the total reflection angle becomes very small. A multilayer reflector including alternating layers made of materials having different refractive indices is a main part of the spatial optical system, and serves for various functions such as beam shaping, spot size conversion, and wavelength selection.

On the other hand, unlike such a mainstream spatial optical system, an X-ray waveguide, such as a known polycapillary, propagates X-ray radiation in the state where the X-ray waves are confined, by total reflection, in a wave-guiding portion defined by a uniform substance such as air. In recent years, in order to achieve a miniaturized, high-performance optical system, X-ray waveguides have been studied which propagate electromagnetic waves in the state where the electromagnetic waves are confined in a thin film or a multilayer film.

Proceeding of SPIE, Volume 5974, p. 597414 (2005) (hereinafter cited as Non-patent Document 1), in an article entitled “Ten years of x-ray waveguides: past, present and future”, Cedola et al., disclose a thin-film waveguide including a cladding having two layers and a core that is made of a material uniform in a one-dimensional direction and is disposed between the two layers of the cladding. Journal of Applied Physics, Number 101, p. 054306 (2007) (hereinafter cited as Non-patent Document 2), in an article entitled “X-ray waveguide nanostructures: Design, fabrication, and characterization”, Jarre et al., disclose an X-ray waveguide including a plurality of elemental X-ray waveguides that confine X-rays in a core made of a uniform material in a two-dimensional direction by total reflection at the interface between the core and a cladding and thus guide the X-rays.

The X-ray waveguide of Non-Patent Document 1 confines X-rays in a core made of a uniform material. However, since the direction of the confinement is one-dimensional, X-rays are emitted to other directions without being confined. This results in a large loss. Also, in order to form a single guided mode in this structure, the core is formed to a very small thickness so as to satisfy the requirements for forming the single mode. Accordingly, the power of X-rays to be guided cannot be increased.

In Non-patent Document 2, each elemental X-ray waveguide can independently form a single guided mode, but the modes of adjacent elemental X-ray waveguides are combined to form a plurality of coupled guided modes. Therefore, it is difficult to form a phase-aligned single guided mode. In addition, since the elemental waveguides are arranged in a one-dimensional direction, the section of the guided mode cannot be increased. Consequently, the power of X-rays to be guided cannot be increased. The cross section of the guided mode mentioned herein refers to the region having a high electromagnetic field intensity in the electromagnetic field intensity distribution at the plane of the guided mode perpendicular to the wave-guiding direction, and corresponds, for example, to the mode field diameter of a guided mode in an optical fiber. Furthermore, since a large amount of material that considerably absorbs X-rays is used according to the number of elemental X-ray waveguides, absorption loss is increased.

The “power of X-rays to be guided” mentioned herein refers to the total power of X-rays passing in the wave-guiding direction z, per unit time, through a section of the core perpendicular to the guiding direction z, and is an integration of the z component of the Poynting vectors on the core section over the entire core section. For example, the power of X-rays to be guided corresponds to a photon flux or the like.

### SUMMARY OF THE INVENTION

Accordingly, the present invention provides an X-ray waveguide that exhibits a low propagation loss and can achieve a phase-aligned single guided mode having a large section.

The X-ray waveguide includes a cladding and a core. The core has a periodic structure formed in at least one period direction. The periodic structure includes periodically arranged members made of material having different refractive index real parts. The core is surrounded by the cladding in the plane perpendicular to a wave-guiding direction in which electromagnetic waves are guided. The Bragg angle obtained from the periodicity of the periodic structure is smaller than the total reflection critical angle at which the X-rays are incident on the interface between the cladding and the core. The at least one period direction is defined by the direction of at least one fundamental vector expressing the periodicity of the periodic structure in a plane of the core perpendicular to the wave-guiding direction.

The periodic structure may be made of a mesostructured material. Alternatively, the periodic structure may be made of a mesoporous material.

The X-ray waveguide exhibits a low propagation loss and can achieve a phase-aligned single guided mode having a large section.

Further features of the present invention will become apparent from the following description of exemplary embodiments.

### BRIEF DESCRIPTION OF THE DRAWINGS

FIG. 1 is a schematic representation of a total reflection critical angle at the interface between a cladding and a core of an X-ray waveguide.

FIG. 2 is a sectional view of an X-ray waveguide showing a plane perpendicular to the X-ray guiding direction.

FIGS. 3A and 3B are schematic views of an X-ray waveguide according to an embodiment of the present invention.

FIG. 4 is a schematic view of a part of a core of an X-ray waveguide.

FIG. 5 is a plot of the relationship between the loss of a guided mode formed in an X-ray waveguide and the effective propagation angle.

FIG. 6 is a schematic view of an X-ray waveguide according to another embodiment of the present invention.

FIG. 7 is a representation of an electric field intensity distribution of the X-ray waveguide shown in FIG. 6 at a plane perpendicular to the z direction.

FIG. 8 is a schematic view of an X-ray waveguide according to a first embodiment of the invention.

FIG. 9 is a schematic view of an X-ray waveguide according to a second embodiment of the invention.

FIG. 10 is a schematic view of an X-ray waveguide according to a third embodiment of the invention.

FIG. 11 is a schematic view of an X-ray waveguide according to a fourth embodiment of the invention.

FIG. 12 is a schematic view of an X-ray waveguide according to a fifth embodiment of the invention.

FIG. 13 is a schematic view of an X-ray waveguide according to a sixth embodiment of the invention.

FIG. 14 is a schematic view of an X-ray waveguide according to a seventh embodiment of the invention.

FIG. 15 is a schematic view of an X-ray waveguide according to an eighth embodiment of the invention.

FIG. 16 is a schematic view of an X-ray waveguide according to a ninth embodiment of the invention.

FIG. 17 is a representation of the effective propagation angle of a guided mode in a core.

FIG. 18 is a representation of a two-dimensional periodic structure in a triangular lattice pattern.

### DESCRIPTION OF THE EMBODIMENTS

Embodiments of the present invention will now be described in detail. An X-ray waveguide, according to an embodiment, includes a cladding and a core, and is configured to guide X-rays therethrough in a predetermined direction. The core is made of a material having a periodic structure including periodically arranged members having different refractive index real parts. In the X-ray waveguide of the embodiment, the cladding and the core are arranged in such a manner that the cladding surrounds the core at the plane perpendicular to the direction in which electromagnetic waves are guided (wave-guiding direction). Also, the cladding and the core are provided so that the Bragg angle obtained from the periodicity of the periodic structure is smaller than the total reflection critical angle at least one interface between the cladding and the core, in the period direction that is at least one direction of the fundamental vectors or vectors formed by the sum or difference of the fundamental vectors, expressing the periodicity of the periodic structure at a plane of the core perpendicular to the electromagnetic wave-guiding direction.

In the present invention, X-rays refer to electromagnetic waves having frequencies or wavelengths in a range in which materials have refractive index real parts of 1 or less. More specifically, the X-ray mentioned herein refers to electromagnetic waves having a wavelength of 100 nm or less, including extreme ultraviolet light (EUV light). The X-ray waveguide of the embodiments of the invention controls electromagnetic waves corresponding to X-rays. Hence, electromagnetic waves mentioned herein refer mainly to X-rays, but the disclosed embodiments are not limited thereto. It is known that the real part of the refractive index of a material is smaller than 1 for X-rays, because the frequency of electromagnetic waves having such a short wavelength is so high that the outermost shell electrons of the material cannot respond, unlike the frequency of electromagnetic waves (visible light and an infrared radiation) having wavelengths larger than or equal to those of ultraviolet light. Specifically, the refractive index n of a material for guiding or transmitting X-rays is generally expressed by the following equation (1):

n=1−δ−i\tilde{β}=ñ−i\tilde{β} (1)

In equation (1), δ represents the deviation of the real part from 1, and the imaginary (i) part associated with absorption is represented by:

i\tilde{β}

Since δ is proportional to the electron density ρₑ of a material, the larger the electron density ρₑ of the material, the lower the refractive index real part of the material. The refractive index real part is expressed by the following equation:

ñ=1−δ

Furthermore, the electric density ρₑ is proportional to the atom density ρₐ and the atomic number Z. Accordingly, the refractive index of a material for X-rays is expressed by a complex number. In the specification, the real part of the complex number refers to a refractive index real part or the real part of a refractive index, and the imaginary part of the complex number refers to a refractive index imaginary part or the imaginary part of a refractive index.

When the refractive index real part for electromagnetic waves corresponding to X-rays is maximum, that is, when X-rays propagate in a vacuum, the refractive index real part of air is the largest of substantially all the gases under normal environmental conditions. In the specification, vacuum is considered as a type of medium (or material). Also, in the specification, two or more materials having different refractive index real parts are often two or more materials having different electron densities.

In the description herein, that the phases of guided modes align means not only that the phase difference of electromagnetic fields in a plane perpendicular to the wave-guiding direction is 0 at a time, but also that the phase difference of the electromagnetic fields periodically varies between −Π and +Π according to the spatial refractive index distribution of a periodic structure, wherein Π indicates the amount of phase shift of a guided mode.

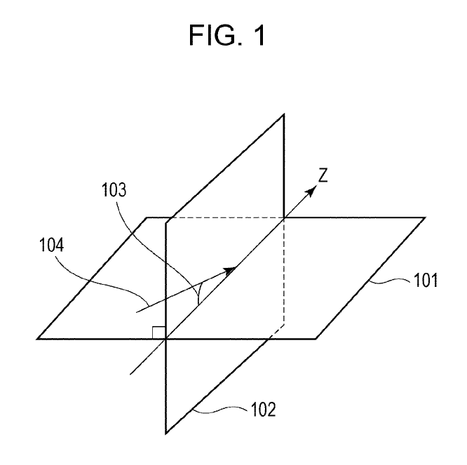

The X-ray waveguide of the embodiments of the invention confines X-rays in the core by total reflection at the interfaces between the core and the cladding and thus guides the X-rays through the waveguide in a predetermined direction. The direction in which X-rays are guided (X-ray guiding direction) is defined as the z direction in a three-dimensional Cartesian coordinate system. When the refractive index real part of the core is larger than the refractive index real part of the cladding around the interface between the core and the cladding, X-rays entering the interface between the core and the cladding at an angle smaller than the total reflection critical angle are totally reflected at this interface and confined in the core. The total reflection critical angle, in this instance, is defined as an angle θ_{C} formed by incident X-rays at the interface between the core and cladding with respect to a plane perpendicular to the interface and parallel to the wave-guiding direction. In FIG. 1, when X-rays are guided in the z direction, an X-ray 104 incident on the interface 101 between a cladding and a core forms an angle 103 with the interface 101 in a plane 102 perpendicular to the interface 101. When X-rays 104 incident at angle 103 are totally reflected at the interface between the core and the cladding, the angle 103 is the total reflection critical angle θ_{C}.

The total reflection critical angle θ_{C} can be calculated by taking into account the indices of refraction of the materials of the core and the cladding. Specifically, when the refractive index real part n_{clad} of the material of the cladding at the interface between the cladding and the core is larger than the refractive index real part n_{core} of the material of the core at the interface (n_{clad}<n_{core}), the total reflection critical angle is expressed by the following equation (2):

$${θ}_{c} = \frac{180}{π} arccos ( \frac{{n}_{clad}}{{n}_{core}} ) \qquad ( 2 )$$

In this instance, the core of the X-ray waveguide of an embodiment of the present invention has a periodic structure including members made of a plurality of materials, and the period and elemental structure of the periodic structure are very small. Therefore, n_{core} of equation (2) does not necessarily represent the strict refractive index real part of a member in the core at the interface between the cladding and the core, and can be considered to be a value between the strict refractive index real part and the average of refractive index real parts in the entirety of the periodic structure.

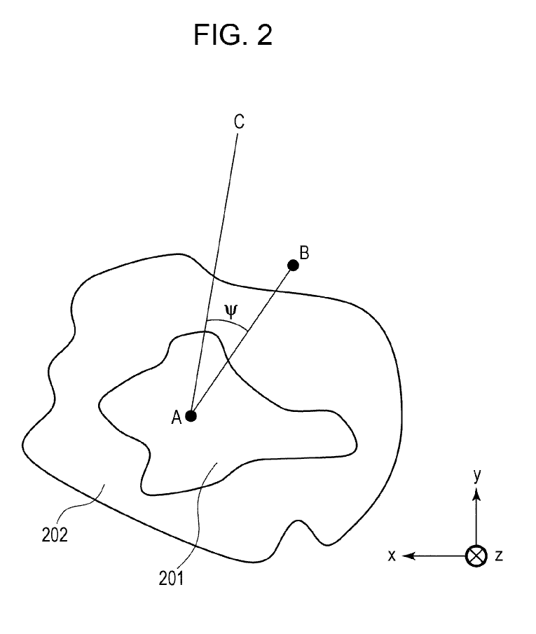

In the X-ray waveguide of the embodiments of the invention, the cladding and the core are arranged in such a manner that the cladding surrounds the core at a plane perpendicular to the X-ray guiding direction. FIG. 2 is a sectional view of the X-ray waveguide taken along a plane perpendicular to the z direction, or the X-ray guiding direction. That is, FIG. 2 is a sectional view of the X-ray waveguide taken along a plane parallel to the x-y plane in the three-dimensional Cartesian coordinate system. That the cladding surrounds the core at the plane perpendicular to the X-ray guiding direction means that a half line AC forming an angle ψ with segment AB connecting point A in the core 201 to point B outside the core 201 intersects with the cladding 202 at any angle ψ of 0° to 360°. Consequently, the X-ray waveguide can confine X-rays in the core in a two-dimensional direction by totally reflecting X-rays at an angle smaller than or equal to the total reflection critical angle from the interface between the cladding and the core, thus guiding the X-rays.

The core of the X-ray waveguide includes periodically arranged members (periodic structure) having different refractive indices. In such an X-ray waveguide, a guided mode of X-rays is formed by the total reflection at the interface between the core and the cladding. The guided mode of X-rays may be a uniform guided mode in which X-rays are not affected much by the periodicity of the periodic structure of the core, or a period resonant mode in which X-rays are considerably affected by the periodicity. The uniform guided mode mentioned herein refers to a guided mode in which the periodic structure of the core is equalized so as to act as a uniform medium on the X-rays. In this mode, the refractive index of the core is substantially uniform for X-rays. On the other hand, in the period resonant guided mode, X-rays are diffracted in a multiple manner by the periodic structure, so that the X-rays resonate strongly with the periodic structure. The period resonant guided mode is a mode in which X-rays resonate with the periodic structure. When the periodic structure is one-dimensional, the periodic resonant mode is involved in one-dimensional Bragg diffraction; when it is two-dimensional, the periodic resonant mode is involved in two-dimensional Bragg diffraction; and when it is three-dimensional, the periodic resonant mode is involved in three-dimensional Bragg diffraction.

In the description herein, at least one direction of the fundamental vectors or vectors formed by the sum or difference of the fundamental vectors, expressing the periodicity of the periodic structure at a plane of the core perpendicular to the electromagnetic wave-guiding direction is referred to as period direction.

The core and cladding of the X-ray waveguide are formed so that the Bragg angle obtained from the periodicity of the periodic structure in at least one of the period directions perpendicular to the wave-guiding direction is smaller than the total reflection critical angle at least one interface between the cladding and the core. Thus, by confining a guided mode that resonates with the periodic structure that causes the Bragg diffraction in the core by the total reflection at the interface between the core and the cladding, a period resonant guided mode can be formed.

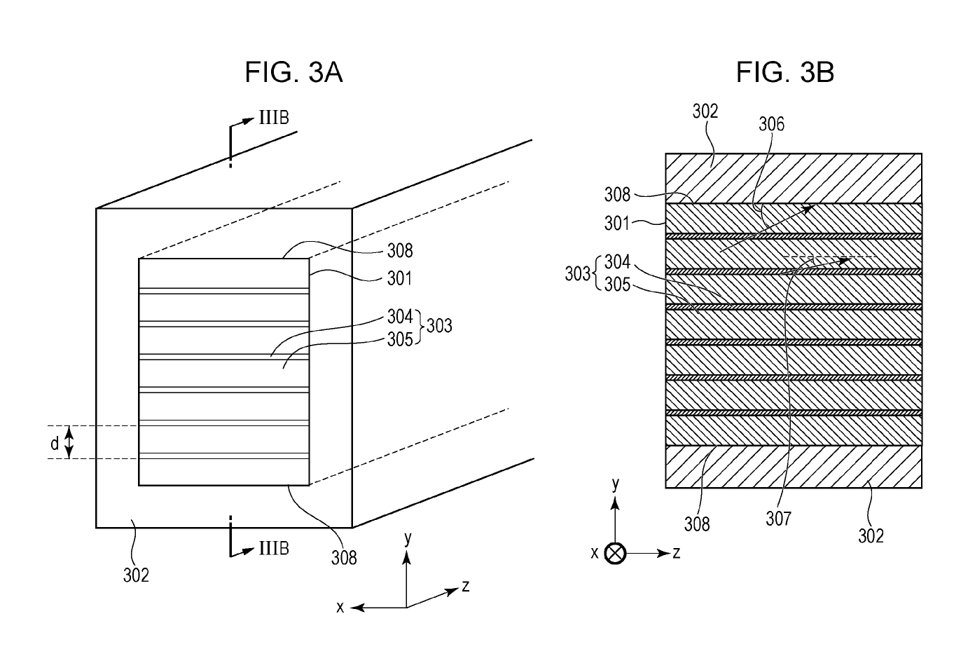

FIGS. 3A and 3B are schematic views of an X-ray waveguide according to an embodiment of the present invention. This X-ray waveguide has a one-dimensional periodic structure. In these figures, X-rays are guided in the z direction. FIG. 3A is a bird's-eye view of the X-ray waveguide, and FIG. 3B is a sectional view showing a section parallel to the y-z plane, taken along line IIIB-IIIB. The core 301 has a one-dimensional periodic structure including elemental structures 303, each including a low refractive index real part layer 304 made of a material having a small refractive index real part and a high refractive index real part layer 305 made of a material having a large refractive index real part. The elemental structures 303 are periodically disposed in the y direction with a period of d. The cladding 302 is disposed so as to surround the core 301 in the x and y directions. The period direction is a direction in which the periodic structure has a periodicity at a plane perpendicular to the electromagnetic wave-guiding direction in the core. The period direction is parallel to a fundamental vector expressing the periodicity of a target periodic structure in the waveguide. In the embodiment shown in FIGS. 3A and 3B, the period direction is the y direction. In FIG. 3B, reference numeral 306 represents the total reflection critical angle θ_{C} measured with respect to the interface 308 between the core and the cladding. X-rays in the core entering the interface 308 at a smaller angle than the total refraction critical angle θ_{C} are totally reflected and confined in the y direction. Reference numeral 307 represents the Bragg angle θ_{B}. The confined X-rays form a guided mode in the direction parallel to the y-z plane. The fundamental wave of each guided mode has a different effective propagation angle θ′(°).

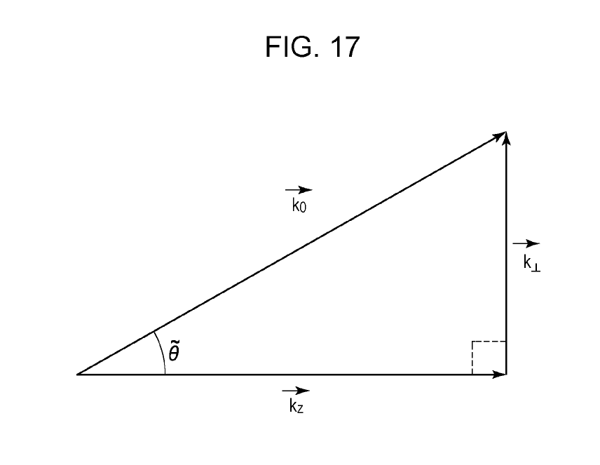

As shown in FIG. 17, when the z component of the wave number vector of a guided mode in the core, that is, the propagation constant, is k_{z} and the wave number vector in a vacuum is K₀, the effective propagation angle is defined by the following equation:

$$\tilde{θ} = \frac{180}{π} arccos ( \frac{{k}_{z}}{{k}_{0}} )$$

Hence, the effective propagation angle θ′(°) is substantially considered to be an angle formed by the propagation direction of the fundamental wave in the guided mode and in the wave-guiding direction.

It is considered that the fundamental waves in each guided mode are mostly reflected at the interface 308 between the core and the cladding at an effective propagation angle θ′(°). Thus, in order to form a desired guided mode, the effective propagation angle θ′(°) is smaller than θ_{C}.

The term fundamental waves mentioned herein refer to electromagnetic waves assumed to propagate at an effective propagation angle θ′(°) with respect to the wave-guiding direction (z direction) when electromagnetic waves forming a guided mode are generalized to a type of plane wave.

Also, in FIG. 17, the wave number vector of fundamental waves in the direction perpendicular to the wave-guiding direction (z direction) is referred to as the perpendicular component k_{⊥} of the wave number vector. The guided mode used in the X-ray waveguide of the embodiments of the invention is a period resonant guided mode, and the effective propagation angle of the period resonant guided mode is close to the Bragg angle θ_{B} obtained from the periodicity of the periodic structure. In order to form a period resonant guided mode, the core and cladding satisfy the relationship θ_{B}<θ_{C}, that is, the relationship in which the Bragg angle obtained from the periodicity of the periodic structure in at least one of the period directions perpendicular to the wave-guiding direction is smaller than the total reflection critical angle at least one interface between the cladding and the core. When the period of the periodic structure in the y direction is d and the average of the refractive index real parts of the core is n_{avg}, the approximate Bragg angle θ_{B} (°) is defined by the following equation (3):

$${θ}_{B} \approx \frac{180}{π} arcsin ( \frac{1}{{n}_{avg}} m \frac{λ}{2 d} ) \qquad ( 3 )$$

In the equation (3), m represents a natural number and λ represents the wavelength of X-rays. However, it is desirable that the Bragg angle be obtained by X-ray diffraction analysis or the like in practice.

Furthermore, in order to form a period resonant guided mode, X-rays are not totally reflected from the interface between the layers of the elemental structure having different refractive index real parts. More specifically, when the total reflection critical angle at the interface between the different materials of the elemental structure is θ_{C-multi}, the relationship θ_{C-multi}<θ_{B} holds true.

As described above, for the X-ray waveguide of the embodiments of the invention, materials are selected so as to satisfy the relationships θ_{B}<θ_{C} and θ_{C-multi}<θ_{B} in the period direction. Consequently, a period resonant guided mode can be formed, and thus X-rays can be guided. Since the electromagnetic field intensity distribution of a period resonant guided mode at a plane perpendicular to the wave-guiding direction is more concentrated in a low-loss material region in the periodic structure, the loss of the period resonant guided mode is considerably reduced. The loss of the period resonant guided mode becomes smaller than the loss of the uniform guided mode having an effective propagation angle close to the effective propagation angle of the period resonant guided mode. Accordingly, under the conditions of the structure of the waveguide that forms a plurality of guided modes including uniform guided modes, as well, the period resonant guided mode becomes more dominant than other guided modes. If the number of periods in the period directions of the periodic structure is increased, the loss of the period resonant guided mode decreases. In practice, the number of periods can be 20 or more. If the core is made of a uniform medium, in general, a single guided mode is formed by considerably reducing the core region. However, by using a core having a periodic structure, the core region can be increased, and a low-loss period resonant guided mode can be formed as a single guided mode in the period direction.

The term “single mode” mentioned herein means that such a mode is more easily selected than the other modes and is nearly or substantially single, or that one of some modes becomes dominant.

In the embodiments of the invention, the period direction of the X-ray waveguide can be defined for any of the directions having periodicity in the periodic structure defining the core. By defining the period direction by a direction having a particularly high periodicity, the effect of the periodicity on a period resonant guided mode can further be enhanced. For example, the periodic structure shown in FIGS. 3A and 3B has periodicity in all directions in the x-y plane other than the x direction, and the most effective periodicity is exhibited in the y direction. In the description herein, the period direction in which the periodicity is most effective is defined as the direction having a periodicity defined by a fundamental vector whose absolute value is the lowest.

The X-ray waveguide of the embodiments of the invention confines X-rays in the period direction by total reflection at the interface between the core and the cladding to form a period resonant guided mode, and, in addition, can confine X-rays in other directions by total reflection. Consequently, X-ray radiation in directions not having structural periodicity can be suppressed, and, thus, the loss can be reduced greatly. The X-ray waveguide shown in FIGS. 3A and 3B, whose core has a one-dimensional periodic structure, does not have structural periodicity in the x direction. Therefore, there is a plurality of uniform guided modes in the x direction. However, by reducing the core region in the x direction, a single guided mode can be formed. The guided mode of the X-rays that are guided in practice is a mixture of guided modes formed in a plurality of confinement directions. However, if a single guided mode is formed in all confinement directions, a substantially single guided mode can be formed in a two-dimensional direction.

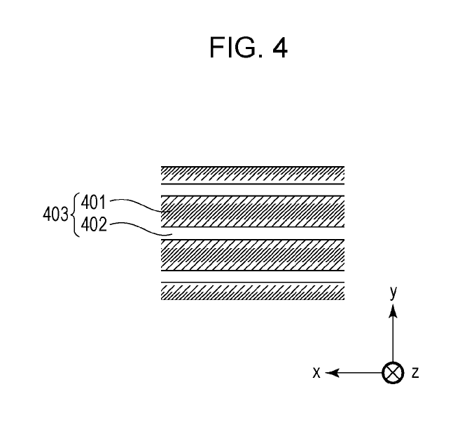

FIG. 4 shows a part of the core of an X-ray waveguide having the same structure as in FIGS. 3A and 3B. The core has a periodic structure including elemental structures 403 disposed on one another in the y direction. Each elemental structure 403 includes a member 402 having a low refractive index real part and a member 401 having a high refractive index real part. In FIG. 4, the diagonally shaded inner region of member 401 has a higher electric field intensity, and the outer region of member 401 and the entirety of member 402 have a lower electric field intensity.

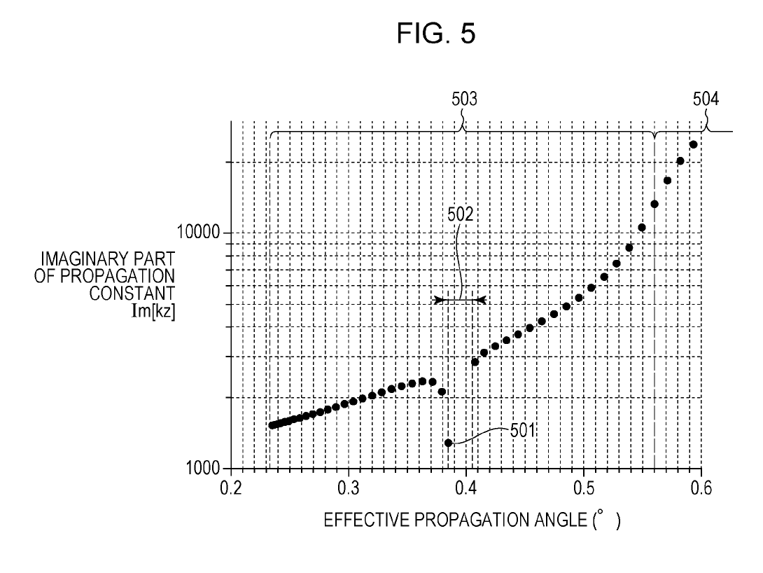

The inventors herein have shown that the loss of period resonant guided mode is reduced by strongly concentrating the electric field of the period resonant guided mode in members 401 having a higher refractive index real part, that is, in low-loss members. FIG. 5 is a plot of the loss of guided modes formed in an X-ray waveguide having a periodic structure as shown in FIG. 4 having 25 periods, with respect to the effective propagation angle of each guided mode. Since the loss of a guided mode is proportional to the imaginary part Im[k_{z}] of the propagation constant, the vertical axis represents Im[k_{z}]. Portion 502 corresponds to the band of Bragg reflection angles. Portion 503 corresponds to the band of effective propagation angles of guided modes, and portion 504 corresponds to the band of emission mode angles larger than the total reflection critical angle at the interface between the core and cladding. The loss 501 of the period resonant guided mode is much smaller than the loss of other guided modes. The loss of the period resonant guided mode can be varied by changing the material or structural parameters. The envelope function of the electromagnetic field distribution of the period resonant guided mode is of trigonometric function in the period direction, and when the distribution has the maximum at the center of the periodic structure, the period resonant guided mode is most stable. In this instance, the leakage of the mode to the cladding is reduced, and the loss is further reduced accordingly.

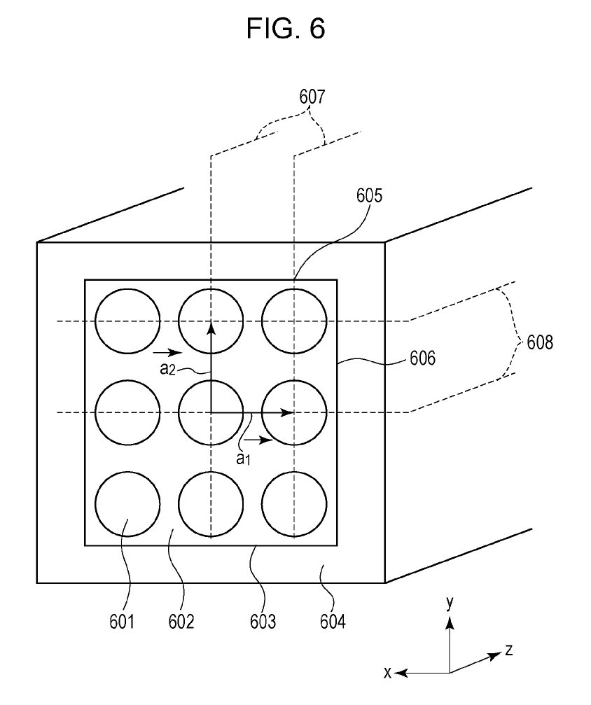

The core of an X-ray waveguide of an embodiment of the invention may have a two-dimensional periodic structure. This structure can form a two-dimensional period resonant guided mode. The two-dimensional periodic structure mentioned herein refers to a structure whose periodicity can be expressed by two fundamental vectors in the plane perpendicular to the wave-guiding direction. For example, as shown in FIG. 6, the core 603 has a two-dimensional structure in the x-y plane. The two dimensional structure includes regions 601 of a material having a higher refractive index real part and a region 602 of a material having a lower refractive index real part. These regions 601 and 602 extend in the z direction and form the core 603. The core 603 is surrounded by a cladding 604. When X-rays are guided in the z direction, the core has a two-dimensional periodic structure in a square lattice arrangement at an x-y plane perpendicular to the wave-guiding direction. The periodicity of the periodic structure is expressed by two fundamental vectors a₁ and a₂ shown in FIG. 6. The number of periods of the periodic structure shown in FIG. 6 is as small as 2 in the x and y directions, for the sake of simplicity of description. The two-dimensional periodic structure includes planes having a fundamental structure repeated in the direction parallel to vector a₁ with a period of |a₁|, and planes having another fundamental structure repeated in the direction parallel to the direction of vector a₂ with a period of |a₂|. The fundamental vectors a₁ and a₂ can be arbitrarily selected as long as they can express periodicity. More specifically, other fundamental vectors can be selected by, for example, different ways, or using a linear combination of fundamental vectors, and planes having fundamental structures corresponding to the selected vectors can be defined. The most fundamental periodicity is expressed by fundamental vectors whose absolute value is the lowest. The effect of the periodicity increases in the directions parallel to such fundamental vectors. The period resonant guided mode can be defined using these directions as the period direction. In the embodiment shown in FIG. 6, when vectors a₁ and a₂ are selected as the fundamental vectors, planes 607 have a fundamental structure for vector a₁, and planes 608 have a fundamental structure for vector a₂. These planes 607 and 608 are periodically repeated in the x direction and the y direction, respectively.

In the X-ray waveguide in which the core has a two-dimensional periodic structure, as well, the core and cladding are formed in such a manner that the Bragg angle is smaller than the total reflection critical angle in at least one of the interfaces between the cladding and the core. More specifically, the core and cladding are formed in such a manner that the Bragg angle obtained from the periodicity of the periodic structure in at least one of the period directions perpendicular to the X-ray guiding direction is smaller than the total reflection critical angle in at least one of the interfaces between the cladding and the core. In the embodiment shown in FIG. 6, one period direction at the x-y plane perpendicular to the wave-guiding direction is the y direction. The cladding and core are formed so that the total reflection critical angle θ_{C} of X-rays at the interface 605 between the core and the cladding in the y-z plane and the Bragg angle θ_{B} obtained from the periodicity in the y direction satisfy the relationship θ_{B}<θ_{C}.

When the core has a two-dimensional structure, the fundamental periodicity is exhibited in two period directions expressed by two fundamental vectors, and accordingly two Bragg angles obtained from the periodicities in the respective directions can be defined. For example, in the X-ray waveguide having the structure shown in FIG. 6, the two period directions are the x direction parallel to fundamental vector a₁, and the y direction parallel to fundamental vector a₂. The Bragg angles θ_{B1} and θ_{B2} obtained from the periodicities of the periodic structure in two period directions parallel to fundamental vector a₁ or a₂ are expressed by the following equations:

$${θ}_{B 1} \approx \frac{180}{π} arcsin ( \frac{1}{{n}_{1 avg}} m \frac{λ}{2 \vert {a}_{1} \vert} )$$

$${θ}_{B 2} \approx \frac{180}{π} arcsin ( \frac{1}{{n}_{2 avg}} m \frac{λ}{2 \vert {a}_{2} \vert} )$$

In the equations, n_{1avg} and n_{2avg} are average refractive indices in the core in the respective two period directions parallel to fundamental vector a₁ or a₂. The total reflection critical angles at an interface 606 or 605 between the core and the cladding in the two period directions parallel to fundamental vector a₁ or a₂ are represented by θ_{1C} and θ_{2C}. For forming period resonant guided modes in the respective directions, materials and structural parameters are set, as with θ_{B}<θ_{C}, for the respective directions, so as to satisfy the relationships θ_{1B}<θ_{1C} and θ_{2B}<θ_{2C}. By satisfying the relationships θ1B<θ_{1C} and θ2B<θ_{2C}, and by setting the total reflection critical angle at the interface between the materials in the core in each direction so as to be smaller than the corresponding Bragg angle, period resonant guided modes can be formed in two period directions. In this waveguide, period resonant guided modes in two directions parallel to two fundamental vectors interfere with each other to form a two-dimensional period resonant guided mode.

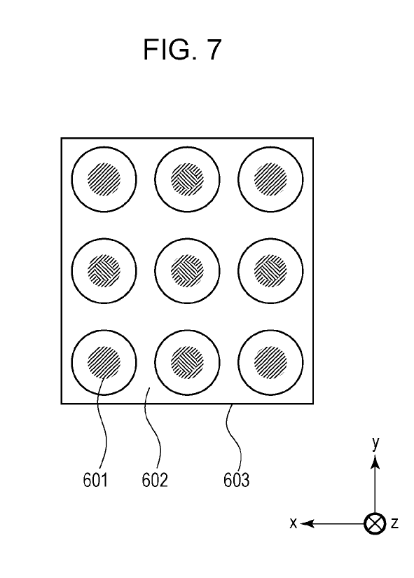

FIG. 7 shows the electric field intensity distribution, at a plane perpendicular to the z direction, of the period resonant guided mode in the core of the periodic structure of the X-ray waveguide shown in FIG. 6. In FIG. 7, the diagonally shaded inner portions of the regions 601 of a material having a higher refractive index real part have a higher electric field intensity, and the portions surrounding the diagonally shaded inner portions of the regions 601 and the region 602 of a material having a lower refractive index real part have a lower electric field intensity. The electric field intensity distribution of the two-dimensional period resonant guided mode formed in the X-ray waveguide including a core having a two-dimensional periodic structure is two-dimensional. Since the electric field is concentrated in regions where loss, such as absorption loss, is lower, it is shown that the propagation loss of the period resonant guided mode is low. As with the one-dimensional period resonant guided mode, the loss of the two-dimensional period resonant guided mode can be reduced to a level lower than that of other guided modes by design, and a single guided mode controlled in a two-dimensional direction can be formed. The electric field distribution or magnetic field distribution of a two-dimensional period resonant guided mode is regularly controlled in the two-dimensional plane perpendicular to the wave-guiding direction, and accordingly, the phase of the electric field or magnetic field is also regular over the entire core.

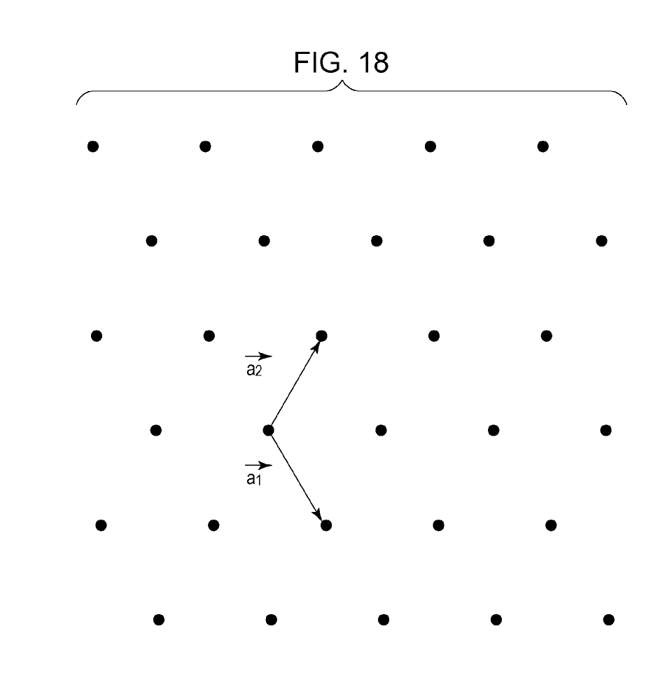

The primitive lattice that defines the periodicity of the two-dimensional periodic structure of the core is not limited to a quadrilateral lattice. In the periodic structure having a quadrilateral lattice pattern shown in FIG. 6, two period directions parallel to two fundamental vectors can be used. However, the period direction is not necessarily defined by these directions, and directions parallel to a vector using a linear combination of fundamental vectors may be used as the period direction. Also, the number of period directions in a two-dimensional plane is not limited to two, and may be three or more depending on the periodicity of the periodic structure. For example, FIG. 18 shows a two-dimensional periodic structure having a triangular lattice pattern, expressed by dots. In addition to the two period directions parallel to fundamental vectors a₁ and a₂, another direction parallel to the third vector represented by a₁+a₂ is used so that X-rays having perpendicular components in three directions interfere to form a two-dimensional period resonant guided mode. In this instance, the electromagnetic field intensity distribution of the period resonant guided mode is in the form of a triangular lattice, and the electromagnetic field is concentrated in portions where absorption loss is lower.

The periodic structure of the core is not limited to one-dimensional or two-dimensional structures, and an X-ray waveguide of an embodiment may include a core having a three-dimensional periodic structure. The concept for forming a period resonant guided mode in a plane perpendicular to the wave-guiding direction is the same as the cases of one-dimensional and two-dimensional periodic structures. Since the three-dimensional periodic structure has a periodicity also in the wave-guiding direction, guided X-rays resonate with the periodic structure, and the phases of the X-rays can be easily aligned in the wave-guiding direction.

One-dimensional periodic structures that can form a core include a one-dimensional periodic multilayer film including alternating layers of a material having a higher refractive index real part and a material having a lower refractive index real part, and other periodic structures that can define a period direction. In other words, two- or three-dimensional structures can also be used by focusing on a specific direction of the structure.

For the one-dimensional periodic multilayer film, examples of the material having a higher refractive index real part include carbon (C), boron carbide (B₄C), boron nitride (BN), and beryllium (Be). Examples of the material having a lower refractive index real part include aluminum oxide (Al₂O₃), magnesium oxide (MgO), silicon carbide (SiC), silicon nitride (Si₃N₄), and titanium oxide (TiO₂). One-dimensional periodic structure may be alternating layers of a material having a higher refractive index real part and a material having a lower refractive index real part, or a periodic mesostructured material produced by a self-assembly process. The one-dimensional periodic mesostructured material may be a structure in which SiO₂ and an organic material are periodically arranged in the direction perpendicular to the surface of a thin film, or a two-dimensional mesoporous material that does not have orientation in a plane having a periodicity in the vertical direction to the plane.

The two-dimensional periodic structure may be a structure of layers having an in-plane periodic pattern formed by patterning thin films of a material having a lower refractive index real part by a semiconductor process, such as electron beam lithography or etching. A single axis-oriented two-dimensional periodic mesostructured material may be used.

The three-dimensional periodic structure may be a three-dimensional periodic mesostructured material having pores with a diameter of several nanometers to several tens of nanometers. Also, an artificial opal structure having a three-dimensional periodic structure may be used in which polystyrene spheres having a diameter of about 50 nm are arranged in a hexagonal close-packed structure in a self-organized manner.

The period of the periodic structure for forming a period resonant guided mode can be about 9 nm or more, depending on the refractive indices of the materials constituting the waveguide. If the period is less than about 9 nm, the confinement of the period resonant guided mode becomes weak.

In an embodiment of the present invention, the core may be made of a mesostructured material or a mesoporous material.

A one-dimensional mesostructured material produced by a self-assembly process will now be described. In the following description, the one-dimensional mesostructured material is referred to as mesostructured lamellar film.

The mesostructured film is a periodic structure having a structural period of 2 to 50 nm. A lamellar structure includes layers of two different materials: one mainly contains inorganic component; and the other mainly contains organic component. The layer mainly containing an inorganic component (inorganic-based layer) and the layer mainly containing an organic component (organic-based layer) may be combined, if necessary. Such a combined material may be a mesostructured material prepared from a siloxane compound combined with an alkyl group.

### Inorganic-Based Layer

The material of the inorganic-based layer is not particularly limited, and may be an inorganic oxide. Exemplary inorganic oxides include silicon oxide, tin oxide, zirconium oxide, titanium oxide, niobium oxide, tantalum oxide, aluminum oxide, tungsten oxide, hafnium oxide, and zinc oxide. The surface of the wall portion of the inorganic-based layer may be modified, if necessary. For example, it may be modified with hydrophobic molecules so as to suppress water adsorption.

### Organic-Based Layer

The organic-based layer is not particularly limited, and the organic component may be a material having a site that functions to form a molecular aggregate and is combined with the material forming the wall portion or a precursor of the material forming the wall portion, such as a surfactant. Such a surfactant may be ionic or nonionic. The ionic surfactant may be a trimethylalkylammonium halide. The alkyl chain of this surfactant may have a carbon number of 10 to 22. The nonionic surfactant may contain polyethylene glycol as a hydrophilic group. Example of the surfactant containing polyethylene glycol as a hydrophilic group include polyethylene glycol alkyl ethers and block copolymers of polyethylene glycol-polypropylene glycol-polyethylene glycol. The alkyl chain of polyethylene glycol alkyl ethers may have a carbon number of 10 to 22, and the number of repetitions of polyethylene glycol may be 2 to 500. By changing the hydrophobic group or the hydrophilic group of the surfactant, the structural period can be varied. In general, by increasing the size of the hydrophobic group and hydrophilic group, the structural period can be increased. The organic-based layer may contain an organic solvent or a salt, as required, or depending on the material used or the manufacturing process. Examples of the organic solvent include alcohols, ethers, and hydrocarbons.

The process for forming the mesostructured film is not particularly limited. For example, an inorganic oxide precursor is added to a solution of an amphiphilic material (particularly a surfactant) that can form a molecular aggregate, and the resulting solution is applied to form a film, followed by promoting a reaction to form an inorganic oxide.

In addition to the surfactant, an additive may be added to adjust the structural period. Such an additive may be a hydrophobic material. Exemplary hydrophobic materials include alkanes and aromatic compounds not having hydrophilic groups, and, for example, octane may be used.

The inorganic oxide precursor may be an alkoxide or a chloride of silicon or a metallic element. Examples of such an inorganic oxide precursor include alkoxides and chlorides of Si, Sn, Zr, Ti, Nb, Ta, Al, W, Hf, and Zn. Exemplary alkoxides include methoxides, ethoxides, propoxides, and alkoxides part of which is substituted with an alkyl group.

The film can be formed by dip coating, spin coating, or hydrothermal synthesis.

A periodic mesostructured material having a two-dimensional or three-dimensional structural period will now be described. Porous materials are classified according to the pore size specified by IUPAC (International Union of Pure and Applied Chemistry), and porous materials having pore sizes of 2 to 50 nm are classified as mesoporous materials. Mesoporous materials are being studied intensively, and a structure in which meso pores with the same diameter are regularly arranged can be obtained by using an aggregate of a surfactant as a template.

Periodic mesostructured materials having a two-dimensional or three-dimensional structural period, used in embodiments of the invention are mesostructured films described above and include the following materials having a two-dimensional or three-dimensional structural period:

(A) mesoporous film; and
(B) mesoporous film whose pores are filled with mainly an organic compound.
These films will be described in detail bellow.

### (A) Mesoporous Film

The mesoporous film is made of a porous material having a pore size of 2 to 50 nm, and the material of the wall portion of the film is not particularly limited. For example, it may be made of an inorganic oxide from the viewpoint of formability. Exemplary inorganic oxides include silicon oxide, tin oxide, zirconium oxide, titanium oxide, niobium oxide, tantalum oxide, aluminum oxide, tungsten oxide, hafnium oxide, and zinc oxide. The surface of the wall portion may be modified, if necessary. For example, it may be modified with hydrophobic molecules so as to suppress water adsorption.

The process for forming the mesoporous film is not particularly limited, and the following method may be applied, for example. A precursor of an inorganic oxide is added to a solution of an amphiphilic material the aggregate of which functions as a template, and the resulting solution is applied to form a film, followed by promoting a reaction to form an inorganic oxide. Then, the template molecule is removed to yield a porous material.

The amphiphilic substance is not particularly limited, and a surfactant is suitable. Such a surfactant may be ionic or nonionic. The ionic surfactant may be a trimethylalkylammonium halide. The alkyl chain of this surfactant may have a carbon number of 10 to 22. The nonionic surfactant may contain polyethylene glycol as a hydrophilic group. Example of the surfactant containing polyethylene glycol as a hydrophilic group include polyethylene glycol alkyl ethers and block copolymers of polyethylene glycol-polypropylene glycol-polyethylene glycol. The alkyl chain of polyethylene glycol alkyl ethers may have a carbon number of 10 to 22, and the number of repetitions of polyethylene glycol may be 2 to 500. By changing the hydrophobic group or the hydrophilic group of the surfactant, the structural period can be varied. In general, by increasing the size of the hydrophobic group and hydrophilic group, the pore size can be increased. In addition to the surfactant, an additive may be added to adjust the structural period. Such an additive may be a hydrophobic material. Exemplary hydrophobic materials include alkanes and aromatic compounds not having hydrophilic groups, and, for example, octane may be used.

The inorganic oxide precursor may be an alkoxide or a chloride of silicon or a metallic element. Examples of such an inorganic oxide precursor include alkoxides and chlorides of Si, Sn, Zr, Ti, Nb, Ta, Al, W, Hf, and Zn. Exemplary alkoxides include methoxides, ethoxides, propoxides, and alkoxides part of which is substituted with an alkyl group.

The film can be formed by dip coating, spin coating, or hydrothermal synthesis.

The template molecule can be removed by firing, extraction, UV irradiation, or ozone treatment.

If the resulting mesostructured film has a structure in which a plurality of pores running in a single axis direction are periodically arranged in a two-dimensional manner in the plane perpendicular to the single axis direction, the film is a two-dimensional periodic mesostructured material having a two-dimensional structural period. If the resulting mesostructured film has a structure in which mesoscale pores are periodically arranged in a three-dimensional manner, the film is a three-dimensional periodic mesostructured material having a three-dimensional structural period.

(B) Mesoporous Film Whose Pores are Filled with Mainly an Organic Compound

The wall portion can be made of the same mesoporous film material as described in (A). Any organic compound can be used to fill the pores without particular limitation. The word “mainly” means that the volume ratio of the organic compound is 50% or more. The organic compound may be a surfactant, or a material having a site that functions to form a molecular aggregate and is combined with the material forming the wall portion or a precursor of the material forming the wall portion. Such a surfactant may be the same as described in (A). Examples of the material having a site that functions to form a molecular aggregate and is combined with the material forming the wall portion or a precursor of the material forming the wall portion include alkoxysilanes having alkyl groups and origosiloxane compounds having alkyl groups. The alkyl chain may have a carbon number of 10 to 22.

The organic compound filling the pores may contain an organic solvent or a salt, as required, or depending on the material used or manufacturing process. Examples of the organic solvent include alcohols, ethers, and hydrocarbons.

The process for preparing the porous film whose pores are filled with mainly an organic compound is not particularly limited, and the process described in (A), but not including the removal of the template molecule nor subsequent steps, may be applied.

As with the case of (A), if the resulting film has a structure in which a plurality of pores running in a single axis direction are periodically arranged in a two-dimensional manner in the plane perpendicular to the single axis direction, the film is a two-dimensional periodic mesostructured material having a two-dimensional structural period. If the resulting film has a structure in which mesoscale pores are periodically arranged in a three-dimensional manner, the film is a three-dimensional periodic mesostructured material having a three-dimensional structural period.

In order to form a period resonant guided mode, the relationships θ_{B}<θ_{C} and θ_{C-multi}<θ_{B} hold true. Accordingly, the material of the cladding is selected according to the materials of the core so that the refractive index real part of the material of the cladding is lower than the refractive index real parts of all the materials of the core. As long as the materials are thus selected, various materials can be used for the cladding. A material having a high electron density can be selected as the material of the cladding, depending on the materials of the core. For example, the cladding may be made of metals such as gold (Au), tungsten (W), titanium (Ti), platinum (Pt), and nickel (Ni), and other materials.

### First Embodiment

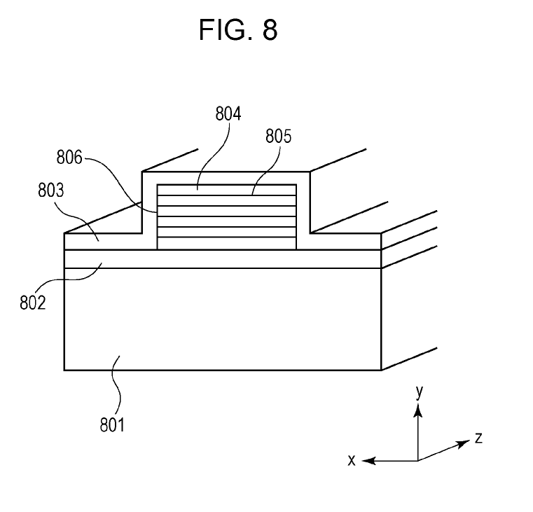

FIG. 8 shows an X-ray waveguide according to a first embodiment of the invention. In the present embodiment, X-rays are guided in the z direction shown in the figure, and each part of the waveguide is continuous in the z direction. The X-ray waveguide has a structure in which a core 806 is surrounded in the plane perpendicular to the wave-guiding direction by a 30 nm thick tungsten (W) member 802 and a 10 nm thick tungsten (W) member 803 on a Si substrate 801. The core 806 is made of a one-dimensional periodic multilayer film having a one-dimensional periodic structure including alternating layers of about 14 nm thick carbon (C) members 804 and about 4 nm thick aluminum oxide (Al₂O₃) members 805, formed in the direction perpendicular to the surface of the Si substrate 801. The one-dimensional periodic multilayer film has a finite width of about 1 μm in the x direction. The number of periods of the multilayer film is 30.

The core 806 is formed by pattering by electron beam lithography and a dry etching process. The tungsten (W) member 803 is formed by sputtering after the patterning of the core 806. The tungsten (W) members 802 and 803 function as a cladding of the X-ray waveguide.

In the present embodiment, the core 806 has a one-dimensional periodic structure, and the period direction, in which the effect of the periodicity is used, is the y direction. For example, for X-rays having a photon energy of 17.5 keV, the total reflection critical angle θ_{C} at the interface between the cladding and the core in the y direction is about 0.25°, and the Bragg angle θ_{B} resulting from the periodicity of the periodic multilayer film is 0.22°. Thus, θ_{B}<θ_{C} is satisfied. Hence, a period resonant guided mode resulting from the periodicity of the one-dimensional periodic multilayer film becomes dominant in the y-z plane, and thus a single low-loss X-ray guided mode can be formed. Since the width of the core 806 of the waveguide in the x direction is large, a plurality of uniform guided modes is present in the z-x plane. Accordingly, the guided mode as a whole that contributes to the propagation of X-rays is a mixture of the period resonant guided mode in the y-z plane and the uniform guided modes in the z-x plane. In addition, since X-rays are confined not only in the y direction, but also in the x direction, by the total reflection at the interfaces between the cladding and the core, the radiation loss of X-rays in the x direction can be considerably reduced.

### Second Embodiment

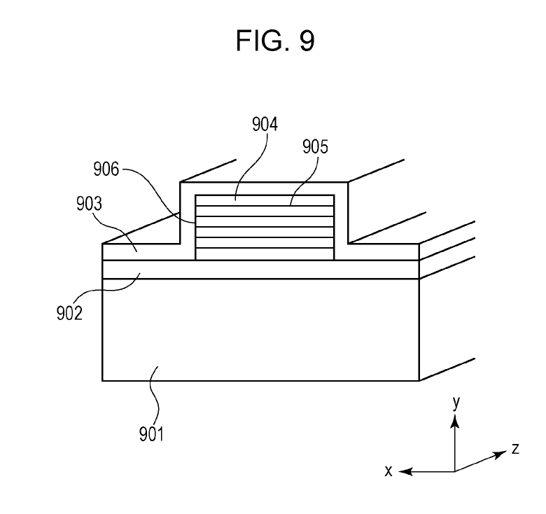

FIG. 9 shows an X-ray waveguide according to a second embodiment of the invention. In the present embodiment, X-rays are guided in the z direction shown in the figure, and each part of the waveguide is continuous in the z direction. In the X-ray waveguide of the present embodiment, a film of a one-dimensional periodic (lamellar) mesostructured material is used as the core instead of the core of the first embodiment. This X-ray waveguide has a structure in which a core 906 is surrounded in the plane perpendicular to the wave-guiding direction by a 30 nm thick tungsten (W) member 902 and a 10 nm thick tungsten (W) member 903 on a Si substrate 901. The core 906 is a film of a one-dimensional periodic (lamellar) mesostructured material and has a one-dimensional periodic structure including alternating layers of about 80 nm thick organic members 904 and about 2 nm thick silica (SiO₂) members, formed in the direction (y direction) perpendicular to the surface of the Si substrate 901. The one-dimensional periodic structure has a finite width in the x direction. The number of periods of the periodic structure is 50.

The core 906 is formed by pattering by electron beam lithography and a dry etching process. The tungsten (W) member 903 is formed by sputtering after the patterning of the core 906. The tungsten (W) members 902 and 903 function as a cladding of the X-ray waveguide.

In the present embodiment, the core 906 has a one-dimensional periodic structure, and the period direction, in which the effect of the periodicity is used, is the y direction. For example, for X-rays having a photon energy of 8 keV, the total reflection critical angle θ_{C} at the interface between the cladding and the core in the y direction is about 0.54°, and the Bragg angle θ_{B} resulting from the periodicity of the periodic multilayer film is 0.49°. Thus, θ_{B}<θ_{C} is satisfied. Hence, a period resonant guided mode resulting from the periodicity of the one-dimensional periodic multilayer film becomes dominant in the y-z plane, and thus a single low-loss X-ray guided mode can be formed. Since the width of the core 906 of the waveguide in the x direction is large, a plurality of uniform guided modes is present in the z-x plane. Accordingly, the guided mode as a whole that contributes to the propagation of X-rays is a mixture of the period resonant guided mode in the y-z plane and the uniform guided modes in the z-x plane. In addition, since X-rays are confined not only in the y direction, but also in the x direction, by the total reflection at the interfaces between the cladding and the core, the radiation loss of X-rays in the x direction can be considerably reduced.

### Third Embodiment

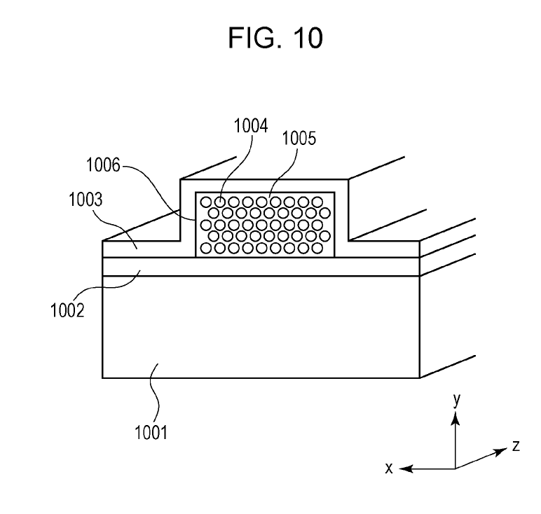

FIG. 10 shows an X-ray waveguide according to a third embodiment of the invention. In the present embodiment, X-rays are guided in the z direction shown in the figure, and each part of the waveguide is continuous in the z direction. This X-ray waveguide has a structure in which a core 1006 is surrounded in the plane perpendicular to the wave-guiding direction by a 20 nm thick tantalum (Ta) member 1002 and an 8 nm thick tantalum (Ta) member 1003 on a Si substrate 1001. The core 1006 is a film of a two-dimensional periodic mesostructured material, and includes a silica portion 1005 in which pores 1004 having a radius of about 4 nm extend in the wave-guiding direction (z direction). The pores 1004 are arranged in the directions perpendicular to the wave-guiding direction (in the directions parallel to the x-y plane) to form a two-dimensional periodic structure having a triangular lattice pattern. The lattice constant is about 11.6 nm.

The core 1006 has been pattered by photo lithography and dry etching, and has a finite width of about 5 μm in the x direction. The tantalum (Ta) member 1003 is formed by sputtering after the patterning of the core 1006. The tantalum (Ta) members 1002 and 1003 function as a cladding of the X-ray waveguide. Since the periodic structure of the core 1006 is two-dimensional, the period direction can be defined as the directions parallel to the two fundamental vectors a₁ and a₂ shown in FIG. 18 illustrating a triangular lattice-like periodicity, and to their linear combination a₁+a₂. The periodic structure is most symmetrical in these three directions, and the electric field of the period resonant guided mode is concentrated in the pores, which are low-loss portions of the periodic structure, and has a two-dimensional periodic distribution. The lattice constant is about 17 nm. Hence, a period resonant guided mode resulting from the two-dimensional periodicity becomes dominant, and thus a single low-loss X-ray guided mode can be formed. In addition, since the width of the core in the x direction is as large as about 5 μm, the power of x rays to be guided is further increased.

For X-rays having a photon energy of 8 keV, the total reflection critical angle θ_{C} at the interface between the cladding and the core in the y direction is about 0.52°, and the Bragg angle θ_{B} resulting from the periodicity of the periodic mesostructured film is 0.47°. Thus, the X-ray waveguide of the present embodiment satisfies θ_{B}<θ_{C}.

### Fourth Embodiment

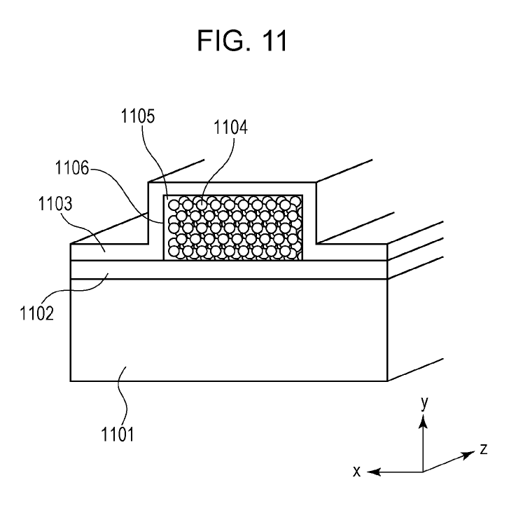

FIG. 11 shows an X-ray waveguide according to a fourth embodiment of the invention. In the present embodiment, X-rays are guided in the z direction shown in the figure, and each part of the waveguide is continuous in the z direction. This X-ray waveguide has a structure in which a core 1103 is surrounded in the plane perpendicular to the wave-guiding direction by a 40 nm thick gold (Au) member 1102 and a 10 nm thick gold (Au) member 1103 on a Si substrate 1101. The core 1106 is a film of a three-dimensional periodic mesostructured material, and spherical voids 1104 with a diameter of about 10 nm filled with an organic material form a hexagonal close-packed structure in a tin oxide (SnO2) portion 1105. The lattice constant is about 11.6 nm.

The core 1106 has been pattered by photo lithography and dry etching, and has a finite width of about 5 μm in the x direction. The gold (Au) member 1103 is formed by sputtering after the patterning of the core 1106. The gold (Au) members 1102 and 1103 function as a cladding of the X-ray waveguide. Since the periodic structure of the core is three-dimensional, the x and y directions, in which the effect of periodicity is produced, are selected as the two period directions parallel to the x-y plane. Thus, two period resonant guided modes resulting from the periodicity in the respective directions can be used.

In the X-ray waveguide of the present embodiment, the period in the y direction is about 15 nm, and the period in the x direction is about 8.7 nm. In the y-z plane, a period resonant guided mode resulting from the periodicity in the y direction becomes dominant, and thus a single low-loss X-ray guided mode can be formed. In the x direction, a period resonant guided mode resulting from the periodicity in the x direction becomes dominant, and thus a single low-loss X-ray guided mode can be formed. In addition, since the width of the core in the x direction is as wide as about 5 μm, the power of x rays to be guided is further increased. Furthermore, the core 1106, which has a three-dimensional structure, has a periodicity also in the z direction. Accordingly, the period resonant guided mode resonating with the periodicity in the x-y plane is affected by the periodicity in the z direction. Consequently, the phase of the guided mode can be easily aligned also in the wave-guiding direction.

For X-rays having a photon energy of 10 keV, the total reflection critical angle θ_{C} at the interface between the cladding and the core in the y direction is about 0.42°, and the Bragg angle θ_{B} resulting from the periodicity of the three-dimensional periodic mesostructured film is 0.31°. Thus, the X-ray waveguide of the present embodiment satisfies θ_{B}<θ_{C}.

### Fifth Embodiment

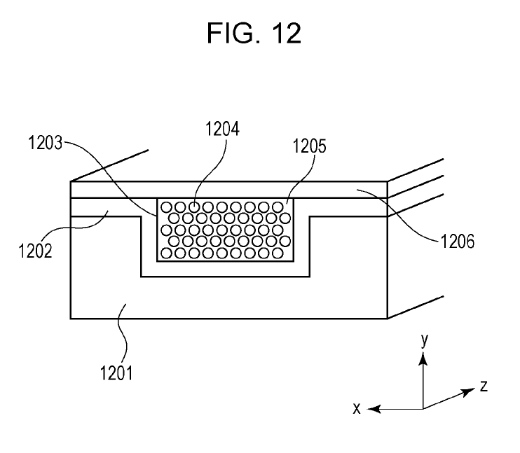

FIG. 12 shows an X-ray waveguide according to a fifth embodiment of the invention. In the present embodiment, X-rays are guided in the z direction shown in the figure, and each part of the waveguide is continuous in the z direction. This X-ray waveguide has a structure in which a core 1203 is surrounded in the plane perpendicular to the wave-guiding direction by a 10 nm thick tungsten (W) member 1206 and a 10 nm thick tungsten (W) member 1202 on a patterned Si substrate 1201. The core 1203 is a film of a two-dimensional periodic mesostructured material, and includes a silica portion 1205 in which pores 1204 having a radius of about 4 nm extend in the wave-guiding direction (z direction). The pores 1204 are arranged in the directions perpendicular to the wave-guiding direction (in the directions parallel to the x-y plane) to form a two-dimensional periodic structure having a triangular lattice pattern. The lattice constant is about 17 nm. The Si substrate 1201, whose surface has a (110) crystal plane, has been pattered by photolithography and anisotropic etching using KOH. The pattern of the substrate 1201 has a finite width of about 5 μm.

After forming the tungsten member 1202 on the patterned Si substrate 1201 by sputtering, the core 1206 is formed of mesoporous silica by a sol-gel process, and the organic material is removed from the pores by firing. Then, another tungsten member 1202 is formed by sputtering. The X-ray waveguide of the present embodiment is thus produced. The tungsten (W) members 1206 and 1202 function as a cladding of the X-ray waveguide. Since the periodic structure of the core 1203 is two-dimensional, the period direction can be defined as the directions parallel to the two fundamental vectors a₁ and a₂ shown in FIG. 18 illustrating a triangular lattice-like periodicity, and to their linear combination a₁+a₂.

The periodic structure is most symmetrical in these three directions, and the electric field of the period resonant guided mode is concentrated in the pores, which are low-loss portions of the periodic structure, and has a two-dimensional periodic distribution. The lattice constant is about 17 nm. Hence, a period resonant guided mode resulting from the two-dimensional periodicity becomes dominant, and thus a single low-loss X-ray guided mode can be formed. In addition, since the width of the core in the x direction is as wide as about 5 μm, the power of x rays to be guided is greatly increased.

For X-rays having a photon energy of 8 keV, the total reflection critical angle θ_{C} at the interface between the cladding and the core in the x direction is about 52°, and the Bragg angle θ_{B} resulting from the periodicity of the two-dimensional periodic mesostructured film is 0.3°. Thus, the X-ray waveguide of the present embodiment satisfies θ_{B}<θ_{C}.

### Sixth Embodiment

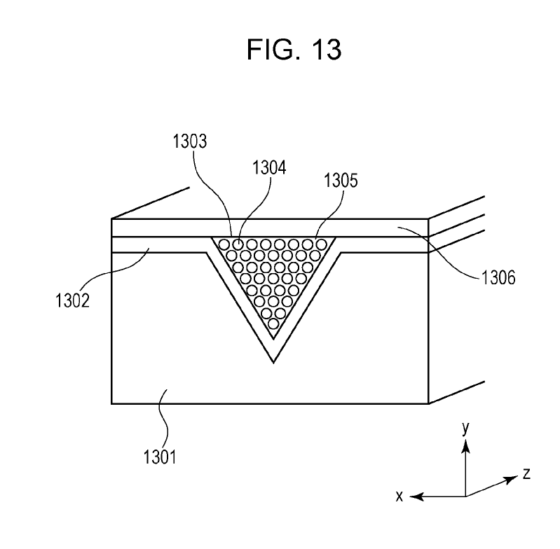

FIG. 13 shows an X-ray waveguide according to a sixth embodiment of the invention. In the present embodiment, X-rays are guided in the z direction shown in the figure, and each part of the waveguide is continuous in the z direction. This X-ray waveguide has a structure in which a core 1303 is surrounded in the plane perpendicular to the wave-guiding direction by a 10 nm thick tungsten (W) member 1302 and a 10 nm thick tungsten (W) member 1306 on a patterned Si substrate 1301. The core 1303 is a film of a two-dimensional periodic mesostructured material, and includes a silica portion 1305 in which pores 1304 having a radius of about 4 nm extend in the wave-guiding direction (z direction). The pores 1304 are arranged in the directions perpendicular to the wave-guiding direction (in the directions parallel to the x-y plane) to form a two-dimensional periodic structure having a triangular lattice pattern. The lattice constant is about 11.6 nm.

The Si substrate 1301, whose surface has a (100) crystal plane, has been pattered by photolithography and anisotropic etching using KOH. The pattern of the substrate 1301 has a triangular section having a finite width of about 7 μm in the x direction and a finite height of about 5 μm in the depth direction. After forming the tungsten member 1302 on the patterned Si substrate 1301 by sputtering, the core 1303 is formed of mesoporous silica by a sol-gel process, and the organic material is removed from the pores by firing. Then, another tungsten member 1306 is formed by sputtering. The X-ray waveguide of the present embodiment is thus produced. The tungsten (W) members 1306 and 1302 function as a cladding of the X-ray waveguide. The periodic structure of the core 1303 is two-dimensional and triangular lattice-like in the x-y in-plane direction. The interfaces between the cladding and the core have substantially equivalent three directions. Accordingly, the period direction can be defined as the directions parallel to the two fundamental vectors a₁ and a₂ shown in FIG. 18 illustrating a triangular lattice-like periodicity, and to their linear combination a₁+a₂.

The periodic structure is most symmetrical in these three directions, and the electric field of the period resonant guided mode is concentrated in the pores, which are low-loss portions of the periodic structure, and has a two-dimensional periodic distribution. The lattice constant is about 17 nm. Hence, a period resonant guided mode resulting from the two-dimensional periodicity becomes dominant, and thus a single low-loss X-ray guided mode can be formed. Even if the three vectors in the x-y in-plane direction of the periodic structure are shifted from the three directions of the interfaces between the cladding and the core, x rays totally reflected at the interfaces resonate with the periodic structure in the three period directions. This resonance can form three period resonant guided modes in the three directions. The electromagnetic intensity distribution in the x-y plane of the period resonant guided modes corresponds to the periodic structure formed with substantially equivalent three fundamental vectors. In the present embodiment, the electromagnetic field is concentrated into the pores, which are low-loss portions of the periodic structure, to form a more low-loss period resonant guided mode. Thus, X-rays can be guided with a low propagation loss.

For X-rays having a photon energy of 8 keV, the total reflection critical angle θ_{C} at the interfaces between the cladding and the core in the directions parallel to vectors a₁, a₂ and a₁+a₂ is about 0.52°, and the Bragg angle θ_{B} resulting from the periodicity of the two-dimensional periodic structure is 0.42°. Thus, the X-ray waveguide of the present embodiment satisfies θ_{B}<θ_{C}.

### Seventh Embodiment

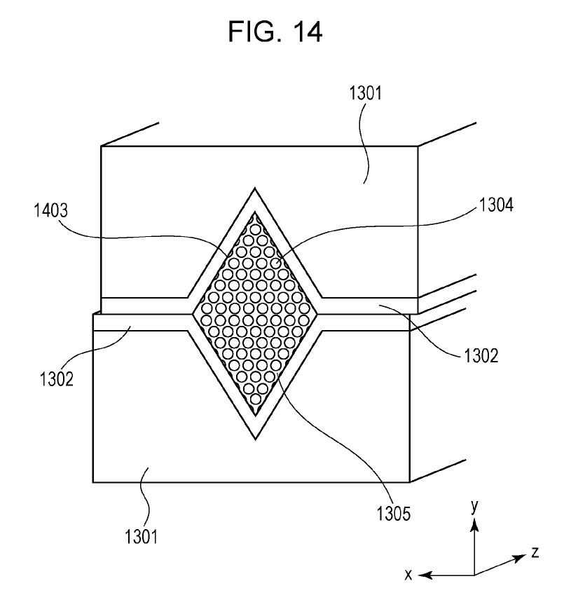

FIG. 14 shows an X-ray waveguide according to a seventh embodiment of the invention. In the present embodiment, X-rays are guided in the z direction shown in the figure, and each part of the waveguide is continuous in the z direction. In the X-ray waveguide of the present embodiment, two X-ray waveguides of the sixth embodiment, but not provided with the tungsten (W) member on the surfaces thereof, are bonded together in such a manner that their top surfaces oppose each other so that their cores come in contact with each other. The core 1403 has a rhombic shape. This structure has two pairs of opposing interfaces between the cladding and the core, and period resonant guided modes can be formed in the directions perpendicular to these interfaces.

Since the periodic structure has a two-dimensional triangular lattice pattern, two directions parallel to vectors a₁ and a₂, as shown in FIG. 18, are period directions, and period resonant guided modes are dominantly formed in these directions. Therefore, two period resonant guided modes can be formed in directions parallel to two fundamental vectors. These two guided modes interfere to form a guided mode that resonates with a triangular lattice period resonant guided mode. The electromagnetic intensity distribution of this guided mode is concentrated into the pores in which loss is low. The core is made of mesoporous silica having pores, and its lattice constant is about 14 nm.

For X-rays having a photon energy of 8 keV, the total reflection critical angle θ_{C} at the interfaces between the cladding and the core in the two period directions is about 0.52°, and the Bragg angle θ_{B} resulting from the periodicity of the two-dimensional periodic structure is 0.36°. Thus, the X-ray waveguide of the present embodiment satisfies θ_{B}<θ_{C}.

### Eighth Embodiment

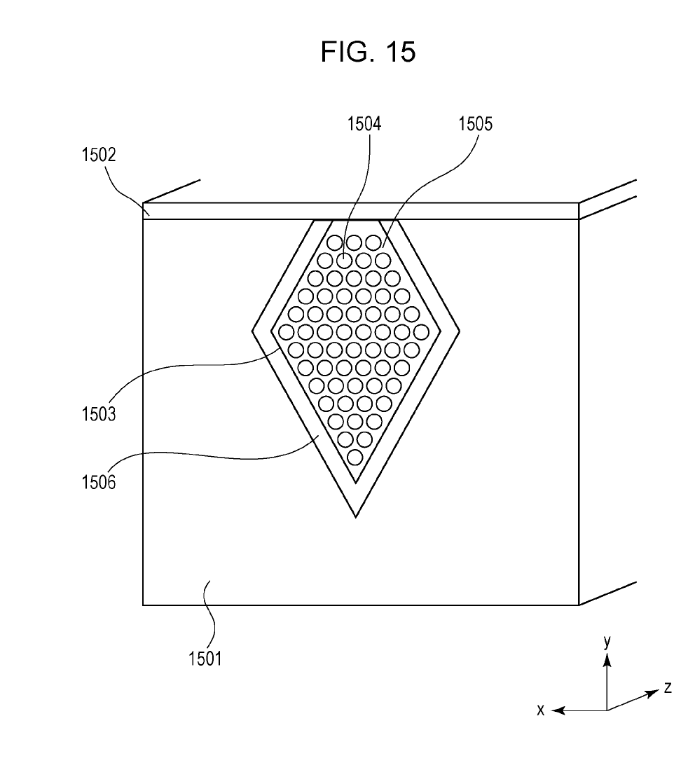

FIG. 15 shows an X-ray waveguide according to an eighth embodiment of the invention. In the present embodiment, X-rays are guided in the z direction shown in the figure, and each part of the waveguide is continuous in the z direction. This X-ray waveguide has a structure in which a core 1503 is surrounded in the plane perpendicular to the wave-guiding direction by a 20 nm thick tungsten (W) member 1506 and a 20 nm thick tungsten (W) member 1502 on a patterned Si substrate 1501. The core 1503 is a film of a two-dimensional periodic mesostructured material, and includes a silica portion 1505 in which pores 1504 having a radius of about 4 nm extend in the wave-guiding direction (z direction). The pores 1504 are arranged in the directions perpendicular to the wave-guiding direction (in the directions parallel to the x-y plane) to form a two-dimensional periodic structure having a triangular lattice pattern. The lattice constant is about 11.6 nm. The surface of the Si substrate 1501 has a (100) crystal plane. A groove having a width of 10 μm and a depth of 100 μm, extending in the direction parallel to the Si substrate 1501 and the (110) plane is formed in the Si substrate with a commercially available dicer (dicing apparatus). Then, the substrate is patterned by an anisotropic etching process using KOH to form a rhombic portion having an opening at the surface of the substrate, in the x-y in-plane direction.

After forming the tungsten member 1506 on the patterned Si substrate 1501 by sputtering, the core 1503 is formed of mesoporous silica by a sol-gel process, and the organic material is removed from the pores by firing. Then, another tungsten member 1502 is formed by sputtering. The X-ray waveguide of the present embodiment is thus produced. The tungsten (W) members 1506 and 1502 function as a cladding of the X-ray waveguide. In the present embodiment, the periodic structure of the core 1503 in the X-y in-plane direction is two-dimensional and triangular lattice-like, and has two pairs of opposing interfaces between the cladding and the core. Accordingly, dominant period resonant guided modes are formed in the same manner as in the seventh embodiment. The period direction is the same two directions as in the seventh embodiment.

For X-rays having a photon energy of 8 keV, the total reflection critical angle θ_{C} at the interface between the cladding and the core in the x direction is about 0.52°, and the Bragg angle θ_{B} resulting from the periodicity of the two-dimensional periodic structure is 0.42°. Thus, the X-ray waveguide of the present embodiment satisfies θ_{B}<θ_{C}.

### Ninth Embodiment

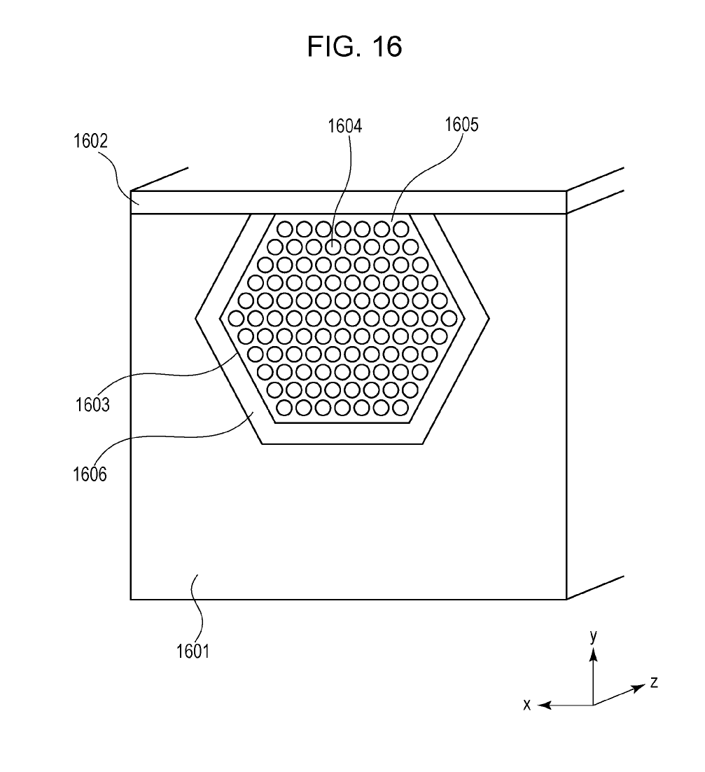

FIG. 16 shows an X-ray waveguide according to a ninth embodiment of the invention. In the present embodiment, X-rays are guided in the z direction shown in the figure, and each part of the waveguide is continuous in the z direction. This X-ray waveguide has a structure in which a core 1603 is surrounded in the plane perpendicular to the wave-guiding direction by a 20 nm thick tungsten (W) member 1606 and a 10 nm thick tungsten (W) member 1602 on a patterned Si substrate 1601. The core 1603 is a film of a two-dimensional periodic mesostructured material, and includes a silica portion 1605 in which pores 1604 having a radius of about 4 nm extend in the wave-guiding direction (z direction). The pores 1604 are arranged in the directions perpendicular to the wave-guiding direction (in the directions parallel to the x-y plane) to form a two-dimensional periodic structure having a triangular lattice pattern. The lattice constant is about 11.6 nm.

The surface of the Si substrate 1601 has a (100) crystal plane. Two grooves having a width of 10 μm and a depth of 100 μm, extending in the direction parallel to the Si substrate 1601 and the (110) plane are is formed in parallel at an interval of 30 μm in the Si substrate 1601 with a commercially available dicer (dicing apparatus). Then, the substrate is patterned by an anisotropic etching process using KOH to form a hexagonal portion having an opening at the surface of the substrate, in the x-y in-plane direction. After forming the tungsten member 1606 on the patterned Si substrate 1601 by sputtering, the core 1603 is formed of mesoporous silica by a sol-gel process, and the organic material is removed from the pores by firing. Then, another tungsten member 1602 is formed by sputtering. The X-ray waveguide of the present embodiment is thus produced.

The portions surrounding the core of the tungsten (W) members 1606 and 1602 function as a cladding of the X-ray waveguide. The periodic structure of the core 1603 is two-dimensional and triangular lattice-like in the x-y in-plane direction, and the waveguide has three pairs of opposing interfaced between the cladding and the core. Therefore, three directions close to the three directions of the fundamental vectors of the periodic structure, perpendicular to the three pairs of the interfaces can be defined as three period directions. Three period resonant guided modes in these three directions interfere to form a guided mode that resonates with triangular lattice period resonant guided modes. The electromagnetic intensity distribution of this guided mode is concentrated into the pores, which are low-loss portions. Thus, X-rays can be guided with a low propagation loss.

For X-rays having a photon energy of 8 keV, the total reflection critical angle θ_{C} at the interfaces between the cladding and the core in the three period directions is about 0.52°, and the Bragg angle θ_{B} resulting from the periodicity of the two-dimensional periodic structure is 0.42°. Thus, the X-ray waveguide of the present embodiment satisfies θ_{B}<θ_{C}.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-093068 filed Apr. 19, 2011, which is hereby incorporated by reference herein in its entirety.

What is claimed is:

1. An X-ray waveguide configured to guide X-rays therethrough in a predetermined direction, comprising:
a cladding; and
a core having a periodic structure formed in at least one period direction, the periodic structure including periodically arranged members made of material having different refractive index real parts, the core being surrounded by the cladding in the plane perpendicular to a wave-guiding direction in which electromagnetic waves are guided,
wherein a Bragg angle obtained from the periodicity of the periodic structure is smaller than the total reflection critical angle at which the X-rays are incident on the interface between the cladding and the core, and
wherein the at least one period direction is defined by the direction of at least one fundamental vector expressing the periodicity of the periodic structure in a plane of the core perpendicular to the wave-guiding direction.

2. The X-ray waveguide according to claim 1, wherein the at least one period direction is defined by the direction of a vector formed by the sum or difference of a plurality of fundamental vectors perpendicular to the wave-guiding direction.

3. The X-ray waveguide according to claim 1, wherein the cladding is disposed so as to surround the core in a direction perpendicular to the wave-guiding direction in which electromagnetic waves are guided.

4. The X-ray waveguide according to claim 1, wherein the periodic structure including periodically arranged members is made of a mesostructured material.

5. The X-ray waveguide according to claim 1, wherein the periodic structure including periodically arranged members is made of a mesoporous material.
